(19) United States
(12) Patent Application Publication
(10) Pub. No.: US 2009/0305107 A1
(43) Pub. Date: Dec. 10, 2009

(54) FUEL CELL AND METHOD OF PRODUCING THE SAME

(75) Inventor: Tomoaki Arimura, Hamura-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/479,199

(22) Filed: Jun. 5, 2009

(30) Foreign Application Priority Data
Jun. 5, 2008 (JP) 2008-148438

(51) Int. Cl. H01M 8/10; H01M 4/04

(52) U.S. Cl. 429/30; 427/595

(57) ABSTRACT

A fuel cell includes an anode having a current collector and a catalyst layer formed on the current collector, wherein an aqueous methanol solution is introduced as fuel into the anode, a cathode having a current collector and a catalyst layer formed on the current collector, wherein an oxidizing agent is introduced into the cathode, and an electrolyte membrane interposed between the anode and the cathode in such a manner as to be in contact with each of the catalyst layers. Each of the catalyst layers includes a catalyst, a perfluoroalkylsulfonic acid polymer and a cross-linked polymer of a sulfonic acid type monomer and a carboxylic acid type monomer. The cross-linked polymer is entangled with the perfluoroalkylsulfonic acid polymer.

### CROSS-REFERENCE TO RELATED APPLICATIONS

This application is based upon and claims the benefit of priority from Japanese Patent Application No. 2008-148438, filed Jun. 5, 2008, the entire contents of which are incorporated herein by reference.

### BACKGROUND

1. Field

One embodiment of the present invention relates to a fuel cell and a method of producing the fuel cell.

2. Description of the Related Art

A direct methanol type fuel cell is provided with an anode into which an aqueous methanol solution is introduced, a cathode into which an oxidizing agent is introduced and a proton conductive membrane interposed between the anode and cathode. The anode and cathode each have a current collector and a catalyst layer formed on the current collector and the above proton conductive membrane is disposed between these catalyst layers. Each catalyst layer is formed from a mixture obtained by mixing a catalyst with Nafion, which is a perfluoroalkylsulfonic acid polymer (trademark, manufactured by Du Pont). The Nafion in each catalyst layer used as a structural resin for the proton conductive membrane has high chemical stability and works to support the catalyst.

The Nafion in each catalyst layer is of a fluorine type and therefore has high affinity to methanol. Such affinity of Nafion has a dissolvable property in methanol. For a direct methanol type fuel cell, an aqueous methanol solution is used for the fuel. Due to this, methanol may contact the Nafion, which elutes, and therefore removes the Nafion little by little. This phenomenon leads to deterioration of the characteristics of the catalyst layer with time. As a result, the reliability of the stack in which plural cells are laminated is lowered.

On the other hand, Jpn. Pat. Appln. KOKAI Publication No. 63-76269 discloses that a graft polymer film is obtained by graft polymerization of polystyrenesulfonic acid on both surfaces of an electrolyte film constituted of a cation exchange film (proton conductive membrane) such as Nafion. Such a graft polymerization film is formed for the purpose of preventing the cation exchange membrane from being eluted by methanol.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematically exploded and perspective view showing a unit cell of a fuel cell according to an embodiment;

FIG. 2 is a sectional view showing a film electrode unit incorporated into a unit cell of FIG. 1;

FIG. 3 is a view showing the result of an analysis made to provide proof of the fixation of Nafion in a catalyst layer of an anode of a membrane electrode obtained in Example 1;

FIG. 4 is a view showing a current-voltage characteristic curve of a unit cell into which an anode and a cathode are incorporated, at 70° C. and which is obtained in each of Examples 1 to 5 and Comparative Example 1;

FIG. 5 is a view showing a current-voltage characteristic curve of a unit cell into which an anode and a cathode are incorporated, at 70° C. and which is obtained in each of Examples 6 to 10 and Comparative Example 1;

FIG. 6 is a view showing a variation in the voltage of a unit cell for evaluation when the unit cell is operated for a long period of time while maintaining a constant current density in each of Examples 1 to 5 and Comparative Example 1; and

FIG. 7 is a view showing a variation in the voltage of a unit cell for evaluation when the unit cell is operated for a long period of time while maintaining a constant current density in each of Examples 6 to 10 and Comparative Example 1.

### DETAILED DESCRIPTION

Various embodiments according to the invention will be described hereinafter. In general, according to one embodiment of the invention, there is provided a fuel cell comprising: an anode having a current collector and a catalyst layer formed on the current collector, an aqueous methanol solution being introduced as fuel into the anode; a cathode having a current collector and a catalyst layer formed on the current collector, an oxidizing agent (for example, air) being introduced into the cathode; and an electrolyte membrane interposed between the anode and the cathode in such a manner as to be in contact with the each catalyst layer, wherein the each catalyst layer includes a catalyst, a perfluoroalkylsulfonic acid polymer and a cross-linked polymer of a sulfonic acid type monomer and a carboxylic acid type monomer, the cross-linked polymer being entangled with the perfluoroalkylsulfonic acid polymer in the catalyst layer. Specifically, the cross-linked polymer exists in the condition that it is entangled with the principal chain —CF₂—CF₂— (perfluoroalkyl chain) of the perfluoroalkylsulfonic acid polymer. Accordingly, the perfluoroalkylsulfonic acid polymer is fixed to each catalyst layer by the cross-linked polymer.

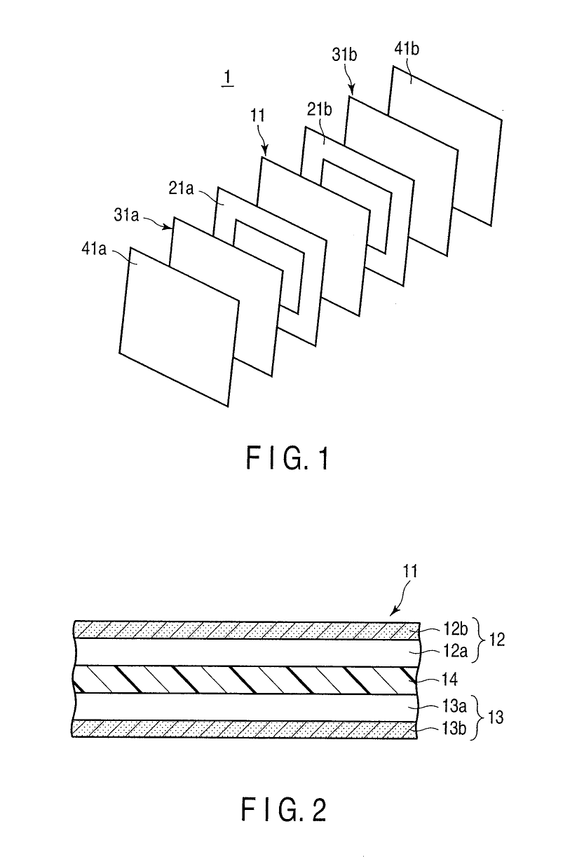

The fuel cell according to this embodiment will be explained in detail with reference to FIGS. 1 and 2. FIG. 1 is a schematically exploded and perspective view showing a unit cell. FIG. 2 is a sectional view showing a film electrode unit incorporated into the unit cell of FIG. 1.

The unit cell 1 is provided with a film electrode unit 11 as shown in FIG. 1. A frame seal material 21a, a fuel passage plate 31a and a current collector plate 41a are arranged and laminated in this order on one surface of the film electrode unit 11. A frame seal material 21b, an oxidizing gas passage plate 31b and a current collector plate 41b are arranged and laminated in this order on the other surface of the film electrode unit 11.

As shown in FIG. 2, the film electrode 11 is provided with an anode 12 into which fuel (aqueous methanol solution) is introduced, a cathode 13 into which an oxidizing agent is introduced, and an electrolyte membrane 14 interposed between the anode 12 and cathode 13. The anode 12 is constituted of a catalyst layer 12a, which is in contact with the electrolyte membrane 14, and a current collector (diffusion layer) 12b, which is laminated on the catalyst layer 12a and made of, for example, carbon paper. The cathode 13 is constituted of a catalyst layer 13a, which is in contact with the electrolyte membrane 14, and a current collector (diffusion layer) 13b, which is laminated on the catalyst layer 13a and made of, for example, carbon paper.

As the catalyst in the anode catalyst layer, for example, a platinum-ruthenium catalyst may be used. As the catalyst in the cathode catalyst layer, for example, a platinum catalyst may be used.

As the perfluoroalkylsulfonic acid polymer, Nafion (trademark, manufactured by Du Pont) may be used.

As the sulfonic acid type monomer, for example, styrenesulfonic acid, allylsulfonic acid or methallylsulfonic acid may be used. Particularly, styrenesulfonic acid, which is an aromatic sulfonic acid type monomer, is preferable.

As the carboxylic acid type monomer, for example, an acrylic acid, methacrylic acid, 3-vinylbenzoic acid or 4-vinyl benzoic acid.

According to another embodiment of the invention, there is provided a method of producing a fuel cell, comprising: heating a mixture containing a sulfonic acid type monomer, a carboxylic acid type monomer and a crosslinking adjuvant to prepare a prepolymer; mixing the prepolymer into a catalyst, a perfluoroalkylsulfonic acid polymer and a photopolymerization initiator to prepare an anode slurry; applying the slurry to one surface of a current collector to form a coating film; irradiating the coating film with light to produce a cross-linked polymer by carrying out to cross-link and polymerize the prepolymer in the coating film, thereby obtaining an anode which comprises the current collector and a catalyst layer formed on the current collector and including the catalyst, the perfluoroalkylsulfonic acid polymer and the cross-linked polymer; heating a mixture including a sulfonic acid type monomer, a carboxylic acid monomer and a crosslinking adjuvant to prepare a prepolymer; mixing the prepolymer into a catalyst, a perfluoroalkylsulfonic acid polymer and a photopolymerization initiator to prepare a cathode slurry; applying the cathode slurry to one surface of a current collector to form a coating film; irradiating the coating film with light to produce a cross-linked polymer by carrying out to cross-link and polymerize the prepolymer in the coating film, thereby obtaining a cathode which comprises the current collector and a catalyst layer formed on the current collector and including the catalyst, the perfluoroalkylsulfonic acid polymer and the cross-linked polymer; and interposing an electrolyte membrane between the anode and the cathode to contact the electrolyte membrane with each catalyst layer of the anode and cathode.

That is, first, a sulfonic acid type monomer, a carboxylic acid type monomer, a crosslinking adjuvant and an initiator such as azobisisobutyronitrile are dissolved in a solvent such as methanol to make a mixture. This mixture is heated to prepare a prepolymer. In succession, the prepolymer is mixed in a catalyst such as a platinum ruthenium catalyst, a solution of a perfluoroalkylsulfonic acid polymer and a photopolymerization initiator to prepare an anode slurry. This slurry is applied to one surface of a current collector in a desired thickness and then, irradiated with light such as ultraviolet rays. At this time, the prepolymer is cross-linked and polymerized in the presence of the catalyst and perfluoroalkylsulfonic acid polymer to produce a cross-linked polymer. The cross-linked polymer is entangled with the perfluoroalkylsulfonic acid polymer and exists in the catalyst layer to fix the perfluoroalkylsulfonic acid polymer. Thus, an anode, which comprises the current collector and a catalyst layer formed on the current collector and including the catalyst, the perfluoroalkylsulfonic acid polymer and the cross-linked polymer, is manufactured.

Also, a cathode is manufactured in the same procedures as in the case of the above anode except that a platinum catalyst is used as the catalyst.

Next, an electrolyte membrane is interposed between the anode and the cathode to contact the electrolyte membrane with each catalyst layer of the anode and cathode, thereby producing a fuel cell.

As the crosslinking adjuvant, for example, pentaerythritol triacrylic acid, di(trimethylolpropane)tetraacrylate and 1,4-divinylbenzene or divinylsulfone may be used.

The heating of the mixture to prepare the prepolymer may be carried out usually at 60° C. to 120° C. for a short time (for example, 60 to 1200 seconds), though this depends on the type of each component.

According to the embodiment explained above, each catalyst layer in the anode and cathode contains a catalyst, a perfluoroalkylsulfonic acid polymer and a cross-linked polymer of a sulfonic acid type monomer and a carboxylic acid type monomer, wherein the cross-linked polymer exists in such a manner as to be entangled with the perfluoroalkylsulfonic acid polymer. In other words, the cross-linked polymer acts as an anchor on the perfluoroalkylsulfonic acid polymer. As a result, the perfluoroalkylsulfonic acid polymer in each catalyst layer is improved in durability to an aqueous methanol solution. This results in an improvement in the reliability of the fuel cell having a stack structure obtained by laminating plural unit cells provided with the anode, the cathode and the proton conductive membrane disposed between the anode and the cathode disposed in contact with each of the above catalyst layers.

In the case of compounding a polystylenesulfonic acid in the catalyst layer containing the catalyst and the perfluoroalkylsulfonic acid polymer by graft polymerization as described in Jpn. Pat. Appln. KOKAI Publication No. 63-76269, a simple graft polymer structure exists in the catalyst layer. As a result, it is difficult to prevent the perfluoroalkylsulfonic acid polymer existing in the catalyst layer from being eluted in methanol. There is also a fear that the perfluoroalkylsulfonic acid polymer is denatured in the graft polymerization, with the result that the catalyst retentivity (binding ability) is impaired.

According to the embodiment, the cross-linked polymer of a sulfonic acid type monomer and carboxylic acid type monomer exists in such a manner as to be entangled with the perfluoroalkylsulfonic acid polymer without any chemical binding reaction, such as graft polymerization with the perfluoroalkylsulfonic acid polymer, and acts as an anchor to thereby fix the perfluoroalkylsulfonic acid polymer in the catalyst layer. This limits the elution of the perfluoroalkylsulfonic acid polymer in methanol satisfactorily, as mentioned above.

Also, the methanol crossover phenomenon can be limited by placing the cross-linked polymer in the catalyst layer of the anode, and therefore, power generation can be improved. The methanol crossover phenomenon is a phenomenon in which methanol, which is the fuel, transmits the proton conductive membrane from the anode and reaches the cathode, which inhibits such an action (reduction) to give electrons to the cathode. Because of this phenomenon, methanol is not converted into electricity but is changed only into heat, leading to a reduction in output and generating efficiency.

According to the embodiment, the methanol crossover phenomenon is reduced, making it possible to improve power generation and also to suppress generation of heat, and therefore, the down-sizing of a fuel cell can be attained.

Also, the embodiment ensures that a method of producing a fuel cell can be provided in which, in each catalyst layer of the anode and cathode, the elution of the perfluoroalkylsulfonic acid polymer in methanol can be limited satisfactorily, whereby the methanol crossover phenomenon is reduced, making it possible to improve power generation and also to suppress generation of heat, and therefore enable down-sizing of a fuel cell.

The present invention will be explained in detail by way of examples.

### Example 1

### Preparation of a Prepolymer (1)

A 200 mL three-neck and round-bottom reaction container equipped with a condenser tube, a dropping funnel, a nitrogen introduction pipe, a stirring rotor, an oil bath and a magnetic stirrer were prepared. The reaction container was charged with 20 parts by weight of styrenesulfonic acid, which was a sulfonic acid type monomer, 30 parts by weight of acrylic acid, which was a carboxylic acid type monomer, and 5 parts by weight of pentaerythritol triacrylate, which was a crosslinking adjuvant, together with 100 parts by weight of ethanol and 0.1 parts by weight of azobisisobutyronitrile, which was an initiator, was added dropwise to the mixture by using the dropping funnel. Then, the mixture was stirred at a reaction temperature of 80° C. under a nitrogen atmosphere for 10 minutes and no refining process was carried out, to prepare a prepolymer (1) in which unreacted polymerizable functional groups were left.

[Preparation of an Anode Raw Material]

100 parts by weight of a 5% perfluoroalkylsulfonic acid polymer (trademark: Nafion, manufactured by Du Pont), 2 parts by weight of a platinum ruthenium catalyst, 20 parts by weight of the above prepolymer (1) and 1 part by weight of benzophenone, which was a photopolymerization initiator, were stirred to prepare a slurry. The obtained slurry was applied to carbon paper (trade name: TPG-H-120, manufactured by Toray Industries, Inc.) by a coater such that the amount of platinum-ruthenium to be carried was 2 mg/cm² to manufacture an anode raw material.

[Preparation of a Cathode Raw Material]

100 parts by weight of a 5% perfluoroalkylsulfonic acid polymer (trademark: Nafion, manufactured by Du Pont), 2 parts by weight of a platinum catalyst, 20 parts by weight of the above prepolymer (1) and 1 part by weight of benzophenone which was a photopolymerization initiator were stirred to prepare a slurry. The obtained slurry was applied to carbon paper (trade name: TPG-H-120, manufactured by Toray Industries, Inc.) by a coater such that the amount of platinum to be carried was 1 mg/cm² to manufacture a cathode raw material.

[Preparation of a Film Electrode]

The obtained anode raw material and cathode raw material were irradiated with ultraviolet rays having a wavelength of 275 nm for one minute. At this time, the prepolymer (1) in the coating film of each raw material was cross-linked and polymerized in the presence of the catalyst, Nafion and the photopolymerization initiator to form a catalyst layer on one surface of the carbon paper. An anode and a cathode were respectively produced by this process. In succession, a Nafion 117 film was interposed between the anode and the cathode as an electrolyte membrane in such a manner as to be in contact with each catalyst layer. Then, the obtained material was treated by hot pressing to manufacture a film electrode.

[Fabrication of a Unit Cell]

The obtained film electrode (electrode area: 5 cm²) was sandwiched between two carbon separators each having a column flow passage and two current collectors, followed by fastening with a bolt to fabricate a unit for evaluation.

<Analysis for Finding Provide Proof of Fixation of Nafion in the Catalyst Layer of the Anode of the Film Eelectrode>

The anode obtained in Example 1 and an anode (Reference Example (1)) in which a catalyst layer produced from Nafion and a platinum-ruthenium catalyst without adding the prepolymer (1) was produced on a current collector were respectively cut into a length of 30 mm to make a sample for measurement.

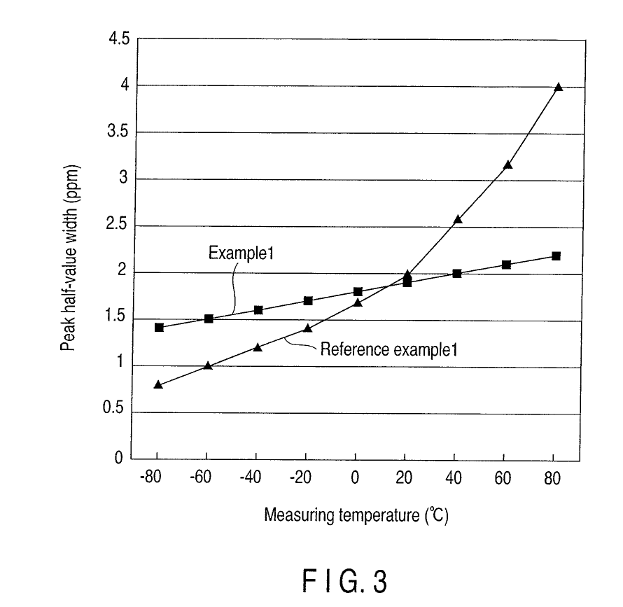

The obtained sample for measurement was inserted into a probe of a nuclear magnetic resonance (NMR) measuring device (trade name: JEOL EX-300, manufactured by JASCO Corporation) to measure ¹⁹F NMR when the temperature was varied between −80° C. and 80° C. The peak of fluorine of the principal chain —CF₂—CF₂— (perfluoroalkyl chain) in the macromolecular structure of Nafion appears at a wavelength close to −140 ppm in general. Based on this peak, the temperature dependence of the half value width of the peak was examined. The results of the temperature dependence of the half value width of the peak of each of the anodes of Example 1 and Reference Example 1 are shown in FIG. 3.

As is clear from FIG. 3, it is understood that the half value width of the NMR peak of fluorine of the perfluoroalkyl chain in the catalyst layer of the anode of Reference Example 1 is increased with increase in temperature. On the other hand, the half value width of the NMR peak of fluorine of the perfluoroalkyl chain in the catalyst layer of the anode of Example 1 varies little with increase in temperature. This is thought to be because, in the crosslinking polymerization of the prepolymer in the catalyst layer of the anode of Example 1, the cross-linked polymer is entangled with the principal chain (perfluoroalkyl chain) of Nafion to thereby fix Nafion, whereby the movement of the principal chain caused by a variation in temperature is decreased, with the result that the NMR peak is not increased with increase in temperature but is broadened.

The same tendency as above was observed in the case of a cathode to which the prepolymer was added.

### Examples 2 to 10

Nine prepolymers (2) to (10) were prepared in the same manner as in Example 1 except that the materials shown in the following Table 1 were selected as the sulfonic acid type monomer, carboxylic acid monomer and crosslinking adjuvant and these components were added in the compounding ratios shown in Table 1. Nine anode raw materials were manufactured in the same manner as in Example 1 except that the slurries used were obtained by compounding a 5% Nafion solution, platinum-ruthenium and each of the obtained prepolymers (2) to (10) in the compounding ratios as shown in the following Table 2.

Nine cathode raw materials were manufactured in the same manner as in Example 1 except that the slurries used were obtained by compounding a 50 Nafion solution, platinum-ruthenium, each of the obtained prepolymers (2) to (10) and benzophenone in the compounding ratios as shown in the following Table 2.

The cathode raw material and anode raw material were irradiated with ultraviolet rays having a wavelength of 275 nm for one minute. Then, each of the prepolymers (2) to (10) in the coating film of each raw material was cross-linked and polymerized in the presence of the catalyst, Nafion and photopolymerization initiator to form a catalyst layer on one surface of the carbon paper. Nine anodes and nine cathodes were respectively manufactured by this process. In succession, a Nafion 117 film was disposed as an electrolyte film between the anode and cathode in such a manner as to be in contact with both the catalyst layers. Then, the resulting product was subjected to hot pressing to manufacture a film electrode and the obtained electrode was used to obtain the same unit cell for evaluation as that obtained in Example 1.

TABLE 1

| | | Prepolymer (compounding ratio: parts by weight) | | | | | | | | | |
|---|---|---|---|---|---|---|---|---|---|---|---|
| Prepolymer component | | (1) | (2) | (3) | (4) | (5) | (6) | (7) | (8) | (9) | (10) |
| Sulfonic acid | Styrenesulfonic acid | 20 | — | — | 20 | — | — | 20 | — | — | 20 |
| type monomer | Allylsulfonic acid | — | 15 | — | — | 15 | — | — | 15 | — | — |
| | Methallylsulfonic acid | — | — | 15 | — | — | 15 | — | — | 15 | — |
| Carboxylic acid | Acrylic acid | 30 | — | — | 25 | — | — | — | — | 30 | — |
| type monomer | Methacrylic acid | — | 10 | — | — | 10 | — | 25 | — | — | — |
| | 3-vinylbenzoic acid | — | — | 5 | — | — | 10 | — | — | — | 10 |
| | 4-vinylbenzoic acid | — | — | — | — | — | — | — | 10 | — | — |
| Crosslinking | Pentaerythritol triacrylate | 5 | — | — | — | 5 | — | — | — | — | — |
| agent | 1,4-divinylbenzene | — | 8 | — | — | — | 6 | 8 | — | — | — |
| | Divinylsulfonic acid | — | — | 1 | — | — | — | — | 4 | — | — |
| | Di (trimethylolpropane) | — | — | — | 0.5 | — | — | — | — | 0.5 | 2 |
| | tetraacrylate | | | | | | | | | | |
| Initiator | Azobisisobutyronitrile | 0.1 | 0.1 | 0.1 | 0.08 | 0.1 | 0.06 | 0.1 | 0.5 | 0.02 | 0.02 |
| Solvent | Ethanol | 100 | 100 | 100 | 100 | 100 | 100 | 100 | 100 | 100 | 100 |

TABLE 2

| | | Example (compounding ratio: parts by weight) | | | | | | | | | |
|---|---|---|---|---|---|---|---|---|---|---|---|
| Electrode | Electrode component | 1 | 2 | 3 | 4 | 5 | 6 | 7 | 8 | 9 | 10 |
| Anode raw | 5% Nafion solution | 100 | 100 | 100 | 100 | 100 | 100 | 100 | 100 | 100 | 100 |
| material | Platinum-ruthenium | 2 | 2 | 2 | 2 | 2 | 2 | 2 | 2 | 2 | 2 |
| | catalyst | | | | | | | | | | |
| | Prepolymer (1) | 10 | — | — | — | — | — | — | — | — | — |
| | Prepolymer (2) | — | 12 | — | — | — | — | — | — | — | — |
| | Prepolymer (3) | — | — | 14 | — | — | — | — | — | — | — |
| | Prepolymer (4) | — | — | — | 10 | — | — | — | — | — | — |
| | Prepolymer (5) | — | — | — | — | 12 | — | — | — | — | — |
| | Prepolymer (6) | — | — | — | — | — | 14 | — | — | — | — |
| | Prepolymer (7) | — | — | — | — | — | — | 10 | — | — | — |
| | Prepolymer (8) | — | — | — | — | — | — | — | 12 | — | — |
| | Prepolymer (9) | — | — | — | — | — | — | — | — | 10 | — |
| | Prepolymer (10) | — | — | — | — | — | — | — | — | — | 10 |
| | Benzophenone | 1 | 1 | 1 | 1 | 1 | 1 | 1 | 1 | 1 | 1 |
| Cathode | 5% Nafion solution | 100 | 100 | 100 | 100 | 100 | 100 | 100 | 100 | 100 | 100 |
| raw | Platinum catalyst | 2 | 2 | 2 | 2 | 2 | 2 | 2 | 2 | 2 | 2 |
| material | Prepolymer (1) | 10 | — | — | — | — | — | — | — | — | — |
| | Prepolymer (2) | — | 12 | — | — | — | — | — | — | — | — |
| | Prepolymer (3) | — | — | 14 | — | — | — | — | — | — | — |
| | Prepolymer (4) | — | — | — | 10 | — | — | — | — | — | — |
| | Prepolymer (5) | — | — | — | — | 12 | — | — | — | — | — |
| | Prepolymer (6) | — | — | — | — | — | 14 | — | — | — | — |
| | Prepolymer (7) | — | — | — | — | — | — | 10 | — | — | — |
| | Prepolymer (8) | — | — | — | — | — | — | — | 12 | — | — |
| | Prepolymer (9) | — | — | — | — | — | — | — | — | 10 | — |
| | Prepolymer (10) | — | — | — | — | — | — | — | — | — | 10 |
| | Benzophenone | 1 | 1 | 1 | 1 | 1 | 1 | 1 | 1 | 1 | 1 |

### Comparative Example 1

100 parts by weight of a 5% perfluoroalkylsulfonic acid polymer (trademark: Nafion, manufactured by Du Pont) and 2 parts by weight of a platinum-ruthenium catalyst were stirred to prepare a slurry. The obtained slurry was applied to carbon paper (trade name: TPG-H-120, manufactured by Toray Industries, Inc.) by using a coater such that the amount of platinum-ruthenium to be carried was 2 mg/cm² to manufacture an anode.

100 parts by weight of a 5% perfluoroalkylsulfonic acid polymer (trademark: Nafion, manufactured by Du Pont) and 2 parts by weight of a platinum catalyst were stirred to prepare a slurry. The obtained slurry was applied to carbon paper (trade name: TPG-H-120, manufactured by Toray Industries, Inc.) by using a coater such that the amount of platinum-ruthenium to be carried was 1 mg/cm² to manufacture a cathode.

A Nafion 117 film as an electrolyte membrane was interposed between the obtained anode and cathode to apply the Nafion film by thermocompression bonding to manufacture a film electrode. Using this film electrode, a unit cell for evaluation was fabricated in the same manner as in Example 1.

<Evaluation of a Unit Cell>

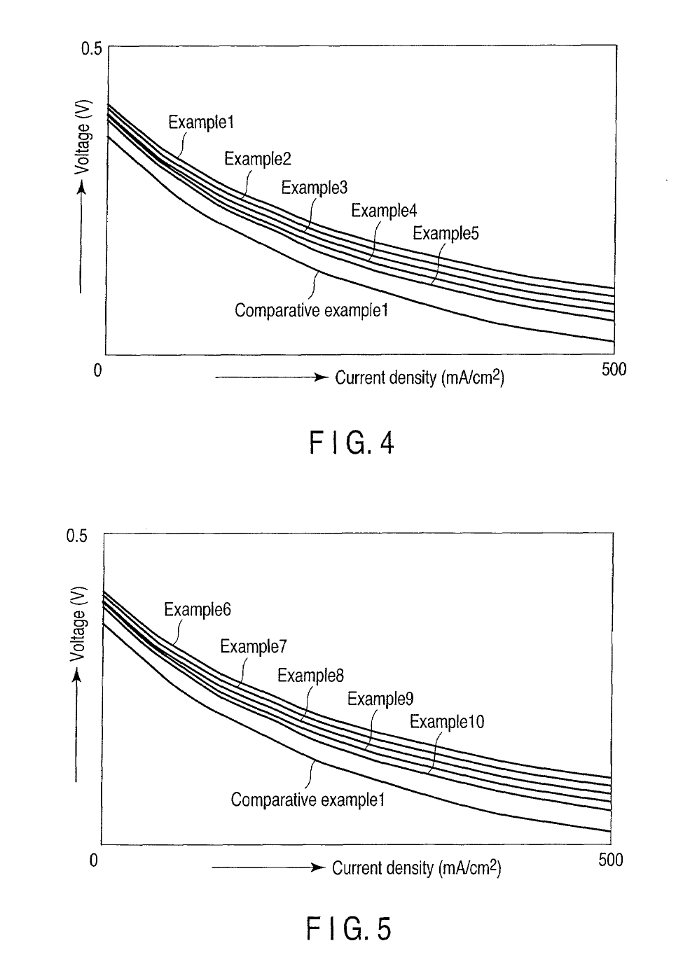

An aqueous 3 wt % methanol solution (fuel) was fed to the anode side of each unit cell obtained in Examples 1 to 10 and Comparative Example 1 at a flow rate of 5 mL/min., and air was fed to the cathode side of the unit cell at a rate of 10 mL/min., to measure the current-voltage characteristic of each unit cell at 70° C. The results are shown in FIGS. 4 and 5.

As is clear from FIGS. 4 and 5, it is understood that the unit cells of Examples 1 to 10 make it possible to draw a higher output voltage than the unit cell of Comparative Example 1. This is because the crossover phenomenon of each unit cell of Examples 1 to 10 was reduced.

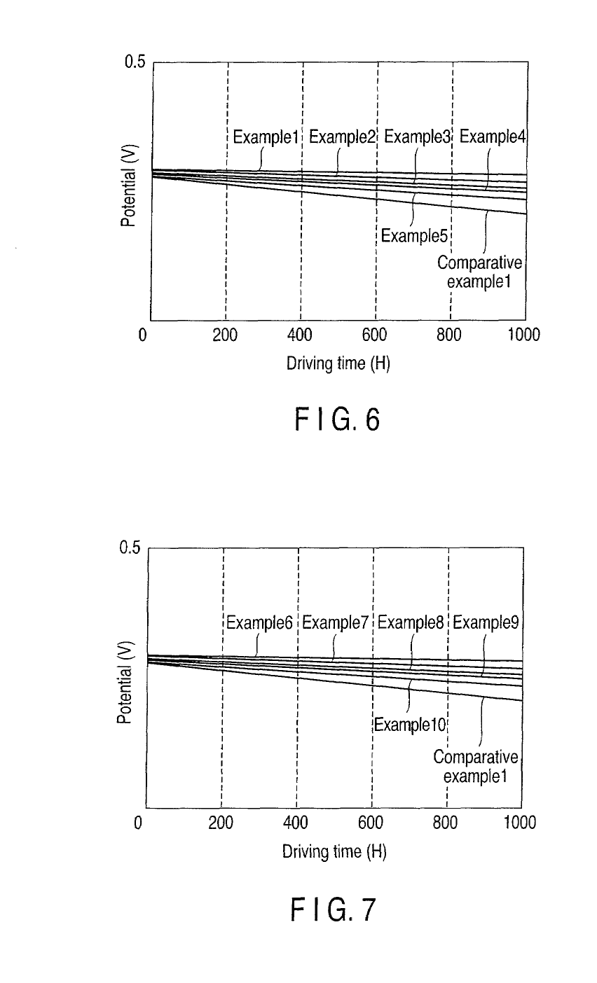

Also, an aqueous 3 wt % methanol solution (fuel) was fed to the anode side of each unit cell obtained in Examples 1 to 10 and Comparative Example 1 at a flow rate of 5 mL/min., and air was fed to the cathode side of the unit cell at a rate of 10 mL/min., to measure a potential variation when the unit cell was operated at 70° C. for 1000 hours while maintaining a current density of 100 mA/cm². The results are shown in FIGS. 6 and 7.

As is clear from FIGS. 6 and 7, it is understood that each unit cell obtained in Examples 1 to 10 exhibits a higher potential retentivity than the unit cell of Comparative Example 1 also after a long-term operation, so that it can attain highly reliable power generation.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fuel cell comprising:
an anode configured to receive an aqueous methanol solution, comprising a current collector and a first catalyst layer on the current collector;
a cathode configured to receive an oxidizing agent, comprising a current collector and a second catalyst layer on the current collector; and
an electrolyte membrane between the first catalyst layer and the second catalyst layer in contact with the first and second catalyst layers,
wherein each catalyst layer comprises a catalyst, a perfluoroalkylsulfonic acid polymer and a cross-linked polymer of a sulfonic acid type monomer and a carboxylic acid type monomer, the cross-linked polymer being entangled with the perfluoroalkylsulfonic acid polymer.

2. The fuel cell of claim 1, wherein each catalyst is formed by heating a mixture comprising a sulfonic acid type monomer, a carboxylic acid type monomer and a crosslinking adjuvant to prepare a prepolymer, by mixing the prepolymer into a catalyst, a perfluoroalkylsulfonic acid polymer and a photopolymerization initiator to prepare a slurry, by applying the slurry to one surface of the current collector in order to form a coating film, and by irradiating the coating film with light in order to produce a cross-linked polymer.

3. The fuel cell of claim 1, wherein the sulfonic acid type monomer is selected from the group consisting of styrenesulfonic acid, allylsulfonic acid and methallylsulfonic acid.

4. The fuel cell of claim 1, wherein the carboxylic acid type monomer is selected from the group consisting of acrylic acid, methacrylic acid, 3-vinylbenzoic acid and 4-vinylbenzoic acid.

5. The fuel cell of claim 1, wherein the catalyst in the first catalyst layer is a platinum-ruthenium catalyst.

6. The fuel cell of claim 1, wherein the catalyst in the second catalyst layer is a platinum catalyst.

7. A method of producing a fuel cell, comprising:
heating a mixture comprising a sulfonic acid type monomer, a carboxylic acid type monomer and a crosslinking adjuvant to be a prepolymer;
mixing the prepolymer into a catalyst, a perfluoroalkylsulfonic acid polymer and a photopolymerization initiator to be an anode slurry;
applying the anode slurry to one surface of a current collector to be a coating film;
irradiating the coating film with light in order to produce a cross-linked polymer, to cross-link and polymerize the prepolymer in the coating film, and to obtain an anode which comprises the current collector and a first catalyst layer on the current collector and comprising the catalyst, the perfluoroalkylsulfonic acid polymer and the cross-linked polymer;
heating a mixture comprising a sulfonic acid type monomer, a carboxylic acid monomer and a crosslinking adjuvant to be a prepolymer;
mixing the prepolymer into a catalyst, a perfluoroalkylsulfonic acid polymer and a photopolymerization initiator to be a cathode slurry;
applying the cathode slurry to one surface of a current collector in order to be a coating film;
irradiating the coating film with light in order to produce a cross-linked polymer, to cross-link and polymerize the prepolymer in the coating film, and to obtain a cathode which comprises the current collector and a second catalyst layer on the current collector and comprising the catalyst, the perfluoroalkylsulfonic acid polymer and the cross-linked polymer; and
setting an electrolyte membrane between the anode and the cathode in contact with the first and second catalyst layers.

8. The method of claim 7, wherein the crosslinking adjuvant is selected from the group consisting of pentaerythritol triacrylic acid, di(trimethylolpropane)tetraacrylate, 1,4-divinylbenzene and divinylsulfone.

9. The method of claim 7, wherein the photopolymerization initiator is azobisisobutyronitrile.

10. The method of claim 7, wherein the light is ultraviolet rays.
